(19) United States
(12) Patent Application Publication
(10) Pub. No.: US 2025/0248462 A1
(43) Pub. Date: Aug. 7, 2025

(54) PREPARATION METHOD FOR WEARABLE RETRACTABLE HEATING ELEMENT

(71) Applicant: MEC ADDHEAT (KAIPING) CO., LTD., Kaiping (CN)

(72) Inventor: Chien Chou Chen, Kaiping (CN)

(21) Appl. No.: 19/189,472

(22) Filed: Apr. 25, 2025

(51) Int. Cl. A41D 13/005; H05B 3/56

(52) U.S. Cl. CPC A41D 13/0051; H05B 3/56; H05B 2203/003; H05B 2203/036

(57) ABSTRACT

The invention relates to the technical field of heating clothing and discloses a preparation method for a wearable retractable heating sheet. A continuous bending U-shaped or inverted U-shaped roundabout preset channel is formed on an elastic fabric, turns around at the half position of a heating path and is arranged in the same continuous bending U-shaped or inverted U-shaped roundabout manner, and a starting end and an ending end of the preset channel are in adjacent positions; a heating wire passes in the starting end of the preset channel and passes out of the ending end of the preset channel. The invention can not only meet the heating function of heating clothing, but also provide the stretching requirements of heating clothing.

### TECHNICAL FIELD

The invention relates to the technical field of heating clothing, in particular to a preparation method for a wearable retractable heating sheet.

### BACKGROUND ART

Heating clothing is an intelligent thermal clothing with built-in heating elements (such as heating wires, carbon fibers, etc.), which generates heat through electric energy and provides active heating function for the wearer and is suitable for outdoor activities in cold environments, winter sports or special working scenarios.

The heating wire materials used in the heating sheets of wearable heating clothes available on the market, whether carbon fiber filaments, metal wires or carbon paste films, generate heat by taking advantage of the high impedance characteristic of the heating wires themselves. However, all heating wires have one thing in common: they cannot stretch or retract. Therefore, the heating sheets in the design of wearable heating clothing cannot be made of stretchable or elastic materials. Heating sheets are usually prepared as sheet bodies with fixed structures and then sewn onto the heating clothing. Even if the heating clothing is made of stretchable elastic fabric, the heating sheets are fixed on the heating clothing and cannot be stretched.

Therefore, improvements are required.

### SUMMARY OF THE INVENTION

The invention aims to provide a retractable heating sheet in view of the defects existing in the prior art in order to solve the problems raised in the background art.

To solve the above technical problems, the invention adopts the following technical proposal: a continuous bending U-shaped or inverted U-shaped roundabout preset channel is formed on an elastic fabric, turns around at the half position of a heating path and is arranged in the same continuous bending U-shaped or inverted U-shaped roundabout manner, and a starting end and an ending end of the preset channel are in adjacent positions; a heating wire passes in the starting end of the preset channel and passes out of the ending end of the preset channel.

Preferably, the preset channel is a hollow channel formed by sewing two layers of elastic fabrics.

Preferably, the preset channel is sewn along the path of the heating wire with the herringbone sewing thread, and the herringbone sewing thread is used to sew and fix the heating wire on the elastic fabric.

Compared with the prior art, the invention has the following beneficial effects:
1. Retractability and wear comfort: the preset channel is combined with the turnaround heating wire, the heating wire is arranged in the preset channel in a continuous U-shaped/inverted U-shaped turnaround manner, and the preset channel extends along with the fabric during stretching, which can prevent the heating wire from being broken. The invention solves the problem that the traditional heating sheet adopts a whole rigid structure that cannot retract, thereby being suitable for the parts (such as knees and waist) that require the retractable function.
2. Preparation process: the preset channel can be formed by sewing the upper/lower elastic fabric for installing the heating wire, or the heating wire can be directly sewn onto the elastic fabric with the herringbone sewing thread to ensure that the heating wire is not torn when the elastic fabric is stretched.

### BRIEF DESCRIPTION OF THE DRAWINGS

FIG. 1 is the schematic diagram for a heating sheet in the invention.

FIG. 2 is the schematic diagram for a local sectioning structure of FIG. 1.

FIG. 3 is the structure diagram of another embodiment of a heating sheet in the invention.

FIG. 4 is the schematic diagram for a local sectioning structure of FIG. 3.

FIG. 5 is the schematic diagram of the invention in the stretched state.

FIG. 6 is the wiring diagram of a heating sheet in the prior art.

FIG. 7 is the wiring diagram of a heating sheet in the prior art.

Reference signs: 1. Elastic fabric; 2. Preset channel; 3. Starting end; 4. Ending end; 5. Heating wire; 6. Upper elastic fabric; 7. Lower elastic fabric; 8. Herringbone sewing thread; 9. Sheet body; 10. Half position of heating path length.

### DETAILED DESCRIPTION OF THE INVENTION

The invention is further described below in combination with the drawings.

The embodiments described with reference to the drawings are exemplary and are intended to explain the invention, but cannot be construed as limitations to the invention. In the description of the invention, it should be understood that terms such as “center”, “longitudinal”, “transverse”, “length”, “width”, “thickness”, “upper”, “lower”, “front”, “rear”, “left”, “right”, “vertical”, “horizontal”, “top”, “bottom”, “inner”, “outer”, “clockwise” and “counterclockwise” indicate orientations or positional relations based on those shown in the drawings. These terms are used solely for ease of description and simplification of the invention, and do not indicate or imply that the referenced device or component must have a specific orientation or be constructed and operated in a particular orientation. Thus, they shall not be construed as limitations to the invention. Furthermore, the terms “first” and “second” are used for descriptive purposes only and shall not be construed as indicating or implying relative importance or implicitly specifying the quantity of the indicated technical characteristics. Thus, characteristics defined with “first” and “second” may explicitly or implicitly include one or more such characteristics. In the description of the invention, the terms “several” and “a plurality of” mean two or more, unless explicitly and specifically defined otherwise. In the invention, unless otherwise expressly specified or limited, terms such as “installed”, “linked”, “connected” and “fixed” shall be interpreted in a broad sense. For example, “connected” may be a fixedly connected, detachably connected, or integrally connected; it may be mechanically connected, electrically connected or directly connected, or may be indirectly connected through an intermediary medium, or even internally connected between two components. Those of ordinary skill in the art can understand the specific meanings of these terms in the invention as the case may be. In the invention, unless otherwise expressly specified or limited, the description that a first characteristic is “on”, “above” or “over” a second characteristic may include direct contact between the first and second characteristics, or may include indirect contact through additional characteristics between them. Moreover, “on”, “above” or “over” may indicate that the first characteristic is directly above or diagonally above the second characteristic, or simply indicate that the level of the first characteristic is higher than that of the second characteristic. he description that the first characteristic is “under”, “below” or “beneath” the second characteristic may indicate that the first characteristic is directly below or diagonally below the second characteristic, or simply indicated that the level of the first characteristic is lower than that of the second characteristic.

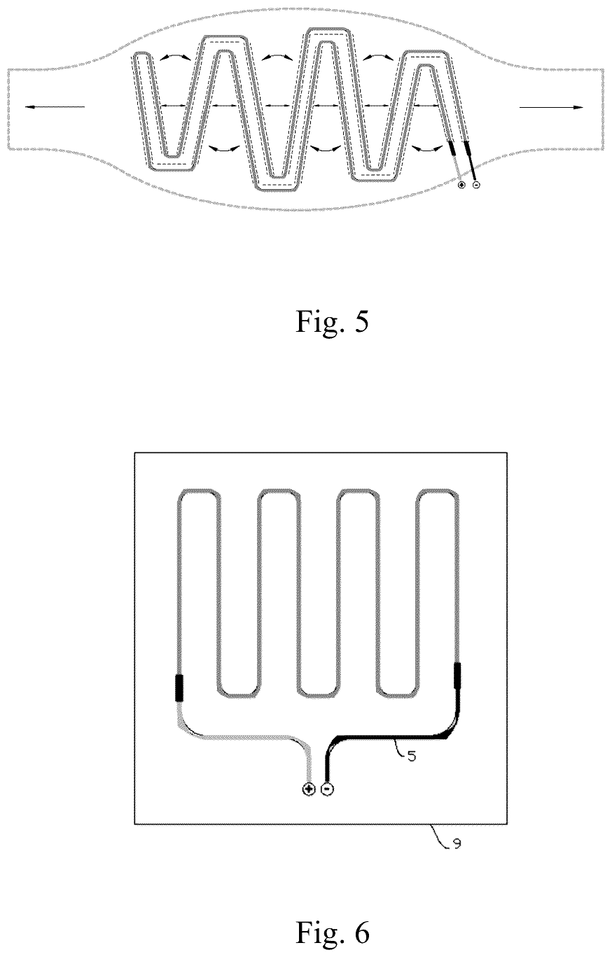

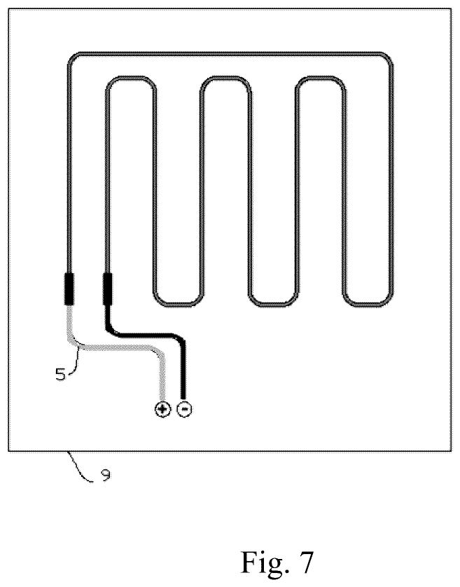

FIG. 5 and FIG. 6 show the preparation form of the heating sheet in the prior art, which is in the form of directly encapsulating the heating wire on the sheet body and cannot achieve stretching.

A preparation method for a wearable retractable heating sheet is provided below.

A continuous bending U-shaped or inverted U-shaped roundabout preset channel 2 is formed on an elastic fabric 1, turns around at the half position of a heating path and is arranged in the same continuous bending U-shaped or inverted U-shaped roundabout manner, and a starting end 3 and an ending end 4 of the preset channel 2 are in adjacent positions; a heating wire 5 passes in the starting end 3 of the preset channel 2 and passes out of the ending end 4 of the preset channel; at this point, the positive and negative electrodes of the heating wire 5 are respectively located at the starting end 3 and the ending end 4 of the preset channel 2.

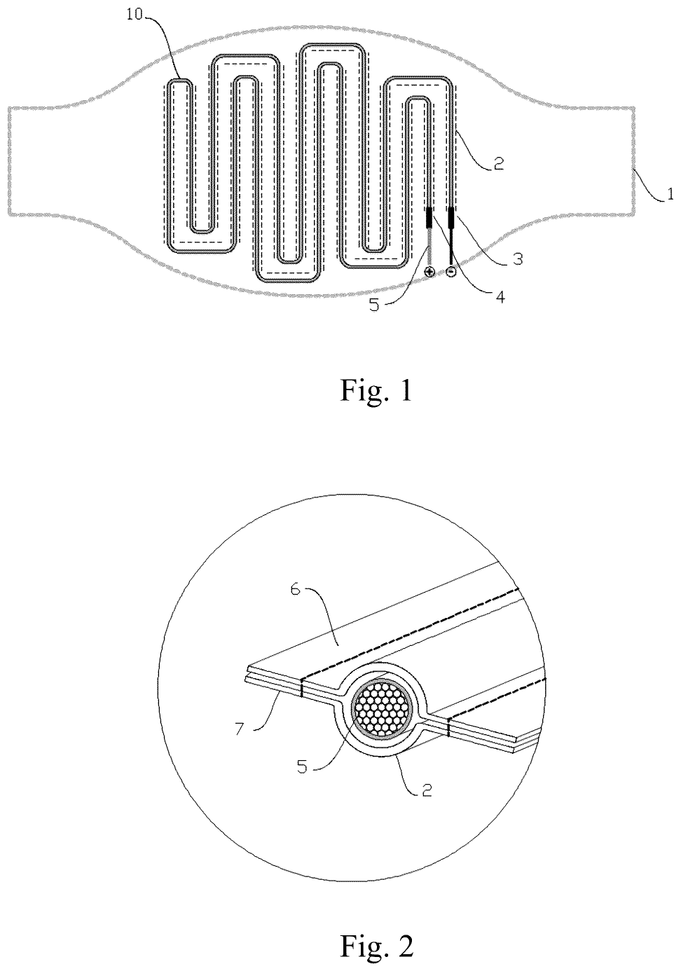

In an implementable preparation method, as shown in FIG. 1 and FIG. 2, the preset channel 2 is a hollow channel formed by sewing an upper elastic fabric 6 and a lower elastic fabric 7. During the processing, the preset channel 2 can be prepared in advance, and then the heating wire 5 passes through the preset channel 2 to complete the processing.

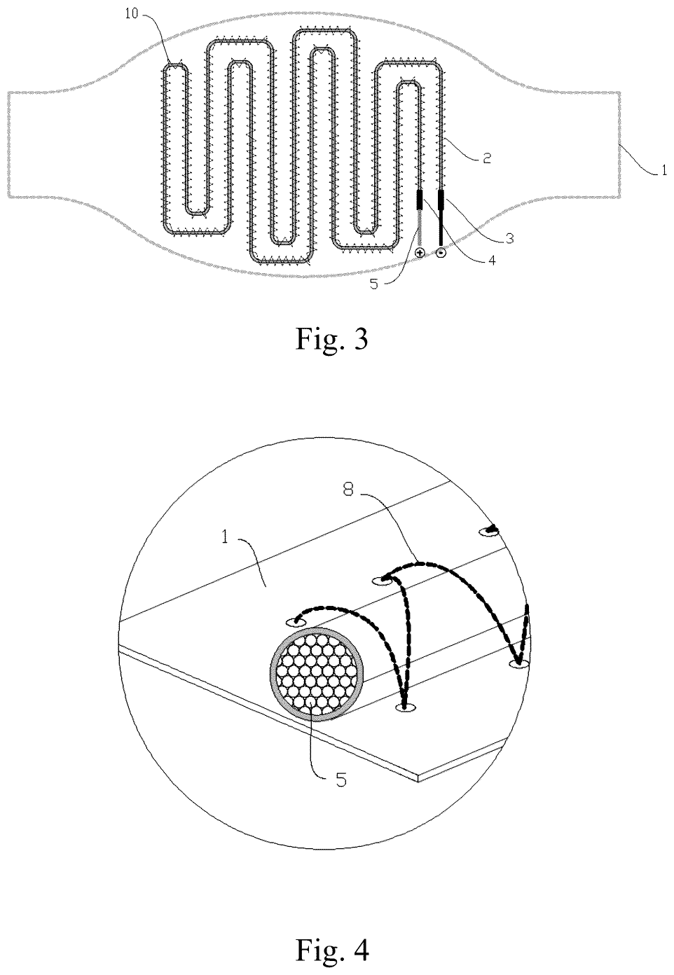

In another implementable preparation method, as shown in FIG. 3 and FIG. 4, the preset channel 2 is sewn along the path of the heating wire 5 with a herringbone sewing thread 8, and the herringbone sewing thread 8 is used to sew and fix the heating wire 5 on the elastic fabric 1. During the processing, the heating wire 5 is arranged along the heating path and then sewn onto the elastic fabric 1 with the herringbone sewing thread 8.

The above does not impose any restrictions on the technical scope of the invention. Any modifications, equivalent variations and refinements made to the above embodiments based on the technical essence of the invention shall still fall within the scope of the technical proposals of the invention.

1. A preparation method for a wearable retractable heating sheet, characterized in that a continuous bending U-shaped or inverted U-shaped roundabout preset channel is formed on an elastic fabric, turns around at the half position of a heating path and is arranged in the same continuous bending U-shaped or inverted U-shaped roundabout manner, and a starting end and an ending end of the preset channel are in adjacent positions; a heating wire passes in the starting end of the preset channel and passes out of the ending end of the preset channel.

2. The preparation method for the wearable retractable heating sheet according to claim 1, characterized in that the preset channel is a hollow channel formed by sewing an upper elastic fabric and a lower elastic fabric.

3. The preparation method for the wearable retractable heating sheet according to claim 1, characterized in that the preset channel is sewn along the path of a heating wire with herringbone sewing thread, and the herringbone sewing thread is used to sew and fix the heating wire on the elastic fabric.
